(19) United States
(12) Patent Application Publication
(10) Pub. No.: US 2014/0099974 A1
(43) Pub. Date: Apr. 10, 2014

(54) APPARATUS AND METHOD FOR MEASURING INDOOR POSITION OF TERMINAL AND PROVIDING TERMINAL WITH PATH GUIDANCE ON BASIS OF FEMTOCELL

(71) Applicant: ELECTRONICS AND TELECOMMUNICATIONS RESEARCH INSTITUTE, Daejeon-si (KR)

(72) Inventors: Sun-Sim CHUN, Daejeon-si (KR); Young-Il KIM, Daejeon-si (KR)

(21) Appl. No.: 13/944,945

(22) Filed: Jul. 18, 2013

(30) Foreign Application Priority Data
Oct. 8, 2012 (KR) 10-2012-0111545

(51) Int. Cl. H04W 4/04

(52) U.S. Cl. CPC H04W 4/043
USPC 455/456.3; 455/456.5

(57) ABSTRACT

Provided are an apparatus and method for measuring an indoor position of a terminal and providing the terminal with path guidance on the basis of a femtocell. The apparatus for measuring an indoor position of a terminal on the basis of a femtocell includes a femtocell base station including a plurality of sensor transmitters respectively transmitting sensor signals for locating the terminal so that the terminal receives the sensor signals and a sensor controller controlling operation of the sensor transmitters, and the terminal configured to receive the sensor signals from the plurality of sensor transmitters, find which sensor transmitters the sensor signals have been transmitted from, and calculate distances between the sensor transmitters having transmitted the sensor signals and the terminal.

### CROSS-REFERENCE TO RELATED APPLICATION

This application claims the benefit under 35 U.S.C. §119(a) of Korean Patent Application No. 10-2012-0111545, filed on Oct. 8, 2012, the entire disclosure of which is incorporated herein by reference for all purposes.

### BACKGROUND

1. Field

The following description relates to an apparatus and method for measuring an indoor position of a terminal and providing the terminal with path guidance on the basis of a femtocell, and more particularly, to an apparatus and method for a femtocell base station having a plurality of sensor transmitters to find an indoor position of a terminal having a sensor receiver, display the found position, a destination, and a path to the destination on an image map, and thereby provide a path guide service to a user carrying the terminal.

2. Description of the Related Art

Description made here merely provides background information on embodiments of the present invention, and does not necessarily constitute related art.

In a method of measuring a position using a global positioning system (GPS), a terminal having a GPS receiver receives respective microwaves transmitted by at least three GPS satellites, acquires the respective distances between the transmitting GPS satellites and the receiving terminal using position information on the GPS satellites and signal arrival information, and calculates a position of the terminal using the respective calculated distances. In the case of mobile communication terminals, the GPS delivers acquired outdoor position information to communication modules, thereby displaying the position information on the respective terminals. In general, the GPS can locate a terminal with a position error of about 5 to 30 m.

However, in a deep valley in which it is impossible to see the sky with a wide view, a downtown area with many buildings, a forest area with many trees, etc., it is difficult for a GPS receiver of a GPS system to receive a satellite signal, and thus location is difficult, or an error may significantly increase even if location succeeds. Moreover, in doors in which it is impossible to directly see a satellite, a GPS receiver cannot receive a satellite signal, and location is impossible. Thus, it is impossible to provide indoor position information.

To enable indoor location of a terminal and reduce an error range of location, a new physical signal was defined in a Long Term Evolution (LTE) system. A positioning reference signal (PRS) is the signal, and the LTE system consecutively transmits the PRS in specific n subframes at predetermined periods (160, 320, 640 or 1280 ms). To transmit a PRS with a low interference level, a frequency-shifted PRS is transmitted from each cell, but data transmission is not allowed in a subframe in which the PRS is transmitted. Although not defined in an LTE system standard, a method in which each terminal randomly transmits a PRS with zero power according to a plurality of base stations to accurately calculate the distances to the base stations, is taken into consideration. However, when there is multipath fading, it is difficult to find an accurate indoor position by transmitting a PRS at predetermined intervals. Thus, inaccuracy in the found position may increase in this case.

Description below concerns an active sensor that employs a method of measuring distance using a time difference of a reflected transmission signal.

Active sensors may be broadly classified into a radio detection and ranging (RADAR) sensor that measures distance by transmitting a radio wave, an ultrasonic sensor that measures distance by transmitting a sound wave, and a light detection and ranging (LADAR) sensor that measures distance by transmitting laser.

A RADAR sensor is mainly used for military or meterorological purposes. However, the radar has been commercialized for advanced cruise control (ACC) of an automobile, and is currently being used to sense surrounding vehicles up to about 150 m ahead. The ACC function is being mainly applied to luxury vehicles only, but used to provide an automatic vehicle-to-vehicle distance maintenance function in connection with an anti-collision function, a brake, etc. and thereby improve the safety of a vehicle.

A position-based sensor that can be used indoors should have a wide sensing angle and also a distance resolution of several centimeters or less. Under these conditions, it is possible to measure a direction of angle (DoA) with a desired resolution. However, it is difficult for a radar to satisfy these two conditions.

When an ultrasonic sensor is used, it is possible to readily implement hardware necessary to calculate a reflection time and measure a distance because a sound wave generally has a slow propagation speed of about 340 m/s. However, since an obstacle, for example, clothes, has a high sound wave absorption ratio, the ultrasonic sensor is seriously affected by distance sensitivity. Also, due to a poor DoA resolution, the ultrasonic sensor has a fatal flaw to be used as an indoor position-based sensor.

On the other hand, a LADAR sensor can adjust a beam width of a laser and particularly make a very small beam width, and thus has excellent distance and spatial resolutions. The LADAR sensor may have a spatial resolution of several centimeters or less, and is a sensor having the best DoA resolution. In particular, an eye-safe infrared (IR) laser has a wavelength range of about 1550 μm, can sense a distance of about tens of meters, and is safe to a person's eye. In spite of a drawback of a high price compared to an IR laser, it is necessary to use the eye-safe IR laser indoors in consideration of safety to eyes.

### SUMMARY

The following description relates to an apparatus and method for a femtocell base station having a plurality of sensor transmitters to find an indoor position of a terminal having a sensor receiver on the basis of indoor location in an indoor public place, display the found position, a destination, and a path to the destination on an image map, and thereby provide a path guide service to a user carrying the terminal.

In one general aspect, an apparatus for measuring an indoor position of a terminal on the basis of a femtocell includes: a femtocell base station including a plurality of sensor transmitters respectively transmitting sensor signals for locating the terminal so that the terminal receives the sensor signals, and a sensor controller controlling operation of the sensor transmitters; and the terminal configured to receive the sensor signals from the plurality of sensor transmitters, find which sensor transmitters the sensor signals have been transmitted from, and calculate distances between the sensor transmitters having transmitted the sensor signals and the terminal.

In another general aspect, an indoor location and path guiding method for a femtocell base station having a plurality of sensor transmitters to measure an indoor position of a terminal having a sensor receiver, includes: sensing approach or presence of the terminal; transmitting sensor signals using all or some of the sensor transmitters; receiving the sensor signals using the sensor receiver, and measuring distances between the terminal and the sensor transmitters having transmitted the sensor signals, and directions from the sensor transmitters having transmitted the sensor signals to the terminal from the received sensor signals to calculate distance information and direction information; and measuring the position of the terminal using the distance information and the direction information to calculate position information.

In still another general aspect, an indoor location and movement path guiding method based on a femtocell including a femtocell base station which finds a position of a terminal having a data communication function and guides a user carrying the terminal to a destination when the terminal enters an interior, includes: sensing approach or presence of the terminal; receiving an input of a destination that the user wants to go to; measuring the position of the terminal to calculate position information; and displaying, at the terminal, an image map stored in the terminal or received from the femtocell base station on a display of the terminal, and displaying the position, the destination, and an estimated path from the position to the destination on the image map.

Other features and aspects will be apparent from the following detailed description, the drawings, and the claims.

### BRIEF DESCRIPTION OF THE DRAWINGS

FIG. 1 is a diagram showing a constitution of a system for implementing an exemplary embodiment of the present invention for locating a terminal and providing path guidance indoors.

FIG. 2 is a diagram illustrating an indoor location method according to an embodiment of the present invention.

FIGS. 3A and 3B are flowcharts illustrating a method of measuring an indoor position of a terminal according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

It will be understood that, although the terms first, second, A, B, (a), (b), etc. may be used herein to describe various elements, these elements should not be limited by these terms. These terms are only used to distinguish one element from another, and do not limit the essence, sequence, etc. of the elements. It will be understood that when an element is referred to as being “connected” or “coupled” to another element, it can be directly connected or coupled to the other element or an intervening element may be “connected” or “coupled” between the respective elements.

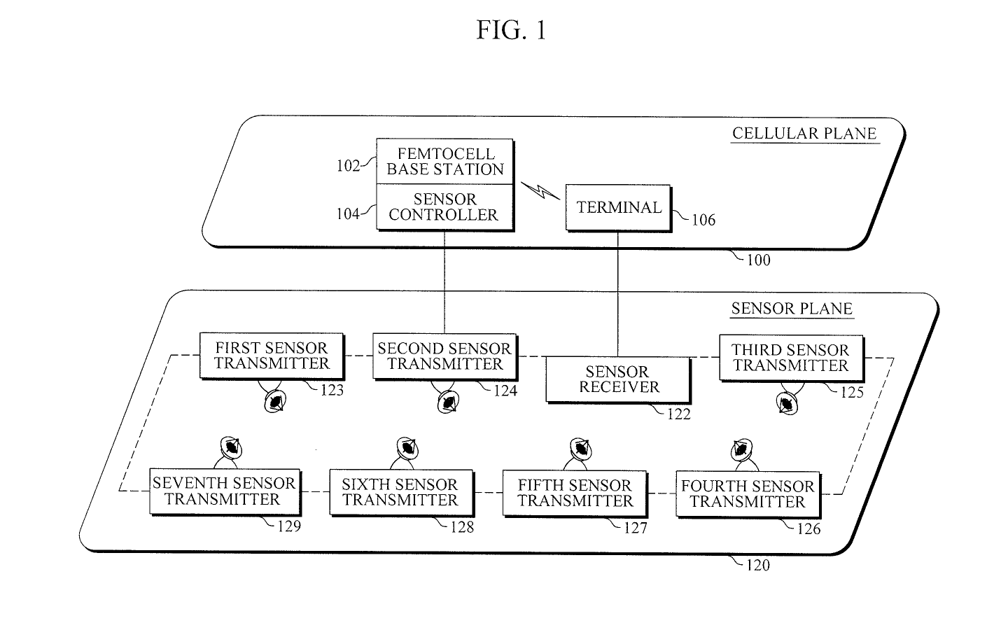

In this embodiment of the present invention, to preciously find a position of a user carrying a terminal in a public place, light detection and ranging (LADAR) technology with high spatial and angular resolutions is applied to a sensor network. FIG. 1 is a diagram showing a constitution of a system for implementing an exemplary embodiment of the present invention for locating a user and providing path guidance indoors. The entire system includes double different networks. The system consists of a cellular plane 100 and a sensor plane 120. The cellular plane 100 includes a femtocell base station 102 and a terminal 106 of a mobile communication system. The sensor plane 120 includes a plurality of sensor transmitters 123 to 129 and a sensor receiver 122 attached to the terminal 106.

The femtocell base station 102 is connected with the sensor plane 120, and a sensor controller 104 for controlling the sensor plane 120 is independently present in the femtocell base station 102. In this specification, the phrase “femtocell base station 102” is used as the same meaning as a femtocell or a femtocell access point (AP), which refers to a very small mobile communication base station that connects to a mobile communication core network via a broadband network installed indoors, such as in a home or an office. In general, a femtocell denotes a base station capable of providing coverage of 10 meters or less as a cell radius. Since a femtocell base station transmits mobile communication data directly to an exchange and not through an indoor repeater, a communication service provider can reduce the cost of network construction and a frequency load, and also improve communication quality. It is possible to use not only voice communication but also the Internet at very high speed, such as wireless fidelity (Wi-Fi). Unlike Wi-Fi that uses a 2.4 GHz band, a femtocell base station also has an advantage in that there is no frequency interference with home appliances, such as a microwave oven.

Among the plurality of sensor transmitters 123 to 129 included in the sensor plane 120, only one sensor transmitter performs transmission at one point in time to remove interference between sensors, and enough transmission time intervals are given to prevent reception problems from being caused by multiple reflections. Also, the sensor plane 120 may be configured to remove interference with the cellular plane 100, that is, interference between a femtocell base station and a sensor network. To this end, sensor transmitters in the sensor plane 120 may be configured to be able to transmit and receive signals using laser or near infrared light.

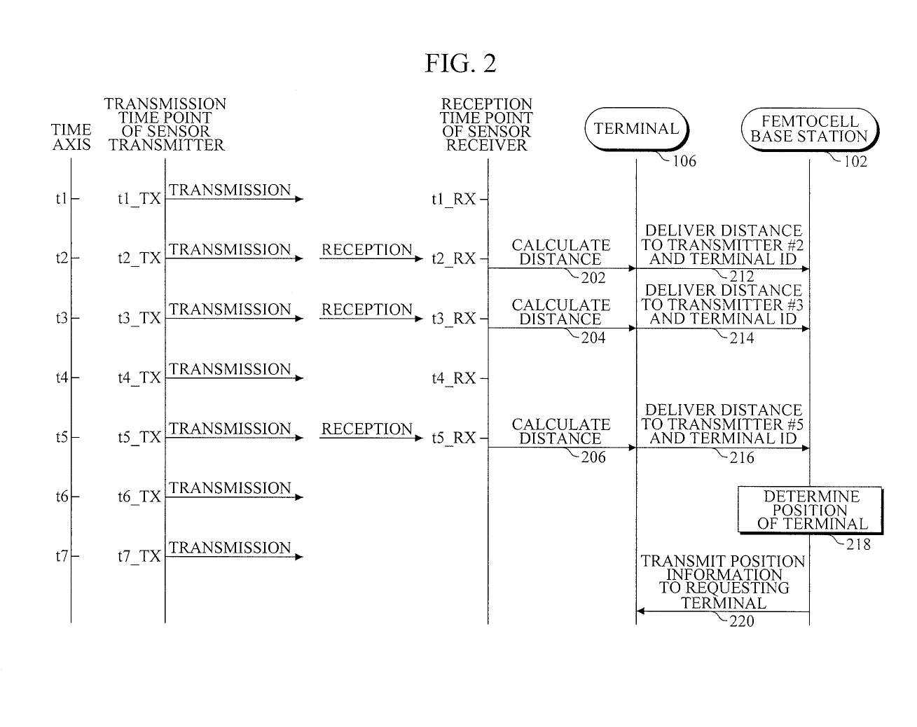

The sensor controller 104 that is included as a part of the femtocell base station 102 or at least directly connected to the femtocell base station 102, determines transmission time points of the respective sensor transmitters 123 to 129 in advance, thereby determining respective transmission start times as shown in FIG. 2. The determined sensor-specific transmission time points are delivered to the terminal 106, and the terminal 106 delivers the information, that is, the sensor-specific transmission time points, to the sensor receiver 122. As shown in FIG. 2, transmission time points of the first to seventh sensor transmitters 123 to 129 are determined to be t1_Tx, t2_Tx, . . . , and t7_Tx, and the sensor receiver 122 of the terminal 106 has acquired information on the transmission time points of the respective sensor transmitters 123 to 129 in advance.

FIG. 2 is a diagram illustrating an indoor location method according to an embodiment of the present invention.

The respective sensor transmitters 123 to 129 transmit sensor signals for locating the terminal 106 at transmission time points t1 to t7 that are separated enough from each other. The sensor signals are denoted by t1_TX to t7_TX, respectively. At respective reception time points t1_RX to t7_RX after a delivery time in accordance with the light velocity, the terminal 106 having the sensor receiver 122 receives the sensor signals transmitted by the first to seventh sensor transmitters 123 to 129. The terminal 106 receiving the sensor signals finds which transmitters the received signals have been transmitted from by reversely calculating transmission time points of the received sensor signals. In other words, using the transmission time points of the first to seventh sensor transmitters 123 to 129 and the already-known light velocity, the terminal 106 calculates distances between the first to seventh sensor transmitters 123 to 129 and the terminal 106. FIG. 2 shows an example in which three sensor transmitters, that is, the second sensor transmitter 124, the third sensor transmitter 125, and the fifth sensor transmitter 127, transmit sensor signals, and the sensor receiver 122 receives the sensor signals. Three sensor signals are enough to calculate a position of the terminal 106.

When the points in time at which the signals transmitted by the respective sensor transmitters 123 to 129 are received by the sensor receiver 122 of the terminal 106 are t1_RX, t2_RX, . . . , and t7_RX, the distances between the first to seventh sensor transmitters 123 to 129 and the terminal 106 are calculated using an equation (ti_Rx−ti_Tx)/c in operations 202, 204, and 206. Here, i=1 to 7 (i is a sensor transmitter index), and c denotes the velocity of light.

As shown in FIG. 2, the respective sensor transmitters 123 to 129 perform transmission at their respective transmission time points, and the terminal 106 delivers information on the distances between the first to seventh sensor transmitters 123 to 129 and the terminal 106 to the femtocell base station 102 in operations 212, 214, and 216, and the femtocell base station 102 delivers this information to the sensor controller 104. At this time, the terminal 106 delivers identifiers (IDs) of all or some of the first to seventh sensor transmitters 123 to 129, an ID of the terminal 106, IDs of some of the first to seventh sensor transmitters 123 to 129 whose sensor signals can be received, and distance information on the sensor transmitters whose sensor signals can be received, to the femtocell base station 102. Using this information, the femtocell base station 102 determines the position of the terminal 106 in operation 218. Here, those of ordinary skill in the art will readily appreciate that determination of the position may be made by the sensor controller 104. When distance information on at least two of the first to seventh sensor transmitters 123 to 129 whose distances have been calculated is obtained, the femtocell base station 102 can know the accurate position of the terminal 106 that is currently communicating with the femtocell base station 102 itself in the femtocell. The femtocell base station 102 transmits information on the found position of the terminal 106 to the terminal 106 or another device in need of the position information in operation 220.

The femtocell base station 102 or the sensor controller 104 obtains the accurate position information on the terminal 106 using the received distance information and direction information on the basis of previously-acquired image map information on an indoor public place. The sensor controller 104 may control the current position of the terminal 106 to be displayed in a map on, for example, a display of the terminal 106. Also, a direction for the terminal 106 to move to a destination is displayed in the map. The map copies the indoor (outdoor in some cases) public place, thereby causing a user to readily recognize his or her position and surroundings, and guiding the user in a movement direction. The displayed map may show a relative position on a plane in the commonest way or in three dimensions. In addition, the map may be a graphic illustration artificially drawn to present the public place, or a combination of pictures of the site taken by a camera that vividly shows the site.

The sensor controller 104 can estimate a movement direction of a specific user who visits a public place, and thus helps the user to readily arrive at a desired destination through an alarm or a visual or acoustic service instructing correction of a path when the user does not move in a desired direction. Here, the meaning of being able to estimate a movement direction of a user is that, for example, when the user makes an appointment to visit a specific treatment part of a hospital at a specific date and time, the movement direction of the user is estimated using the appointment information. More specifically, when the user makes an appointment to visit the ear-nose-and-throat department of a specific hospital at a specific time, the sensor controller 104 acquires information on the date and time of the visit and the specific place to visit in the hospital in advance, and may provide the user with path guidance by comprehensively using a current position of the user, the destination of the user, and previously-stored map information upon sense of the terminal 106 of the user at the entrance, etc. of the hospital.

Meanwhile, according to an embodiment of the present invention, it is possible to provide a service for finding a position and a movement direction of an acquaintance of the user in addition to the service for locating the terminal 106 of the user and path guiding.

If the user of the terminal 106 tries to find the position of the acquaintance of the user determined to be in the same public place, when the position of the acquaintance of the user is also determined through the above-described procedure, and the user requests the position information on the acquaintance through the terminal 106, the femtocell base station 102 displays the position information and the movement direction of the acquaintance on a current map screen of the user. For example, when the user has made an appointment to meet his or her mother and go to a treatment part of a hospital together, the user may arrive at the entrance of the hospital and inquire about a current position and a movement direction of his or her mother, and the system according to an embodiment of the present invention may find and visually or acoustically provide the current position and the movement direction to the terminal 106 of the user.

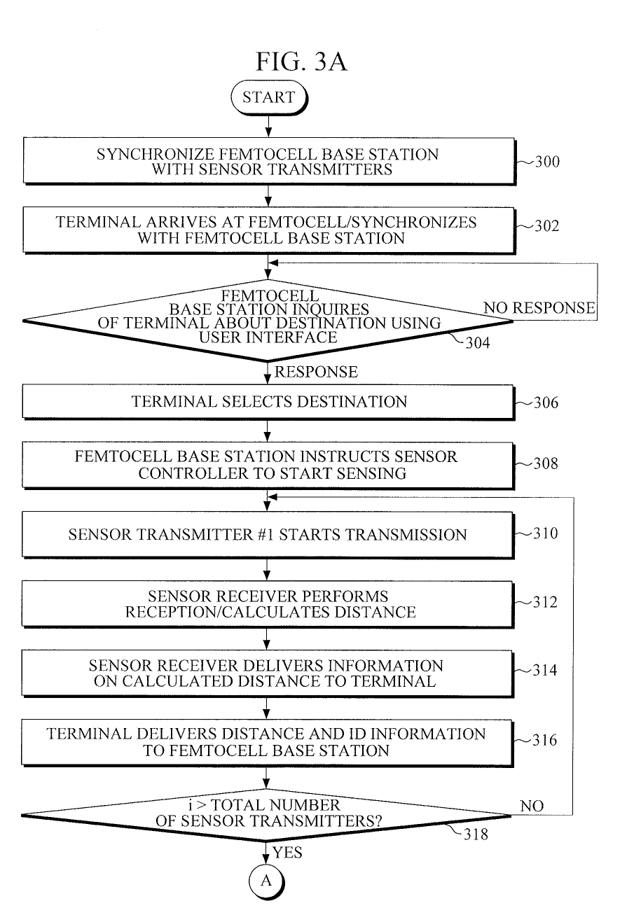

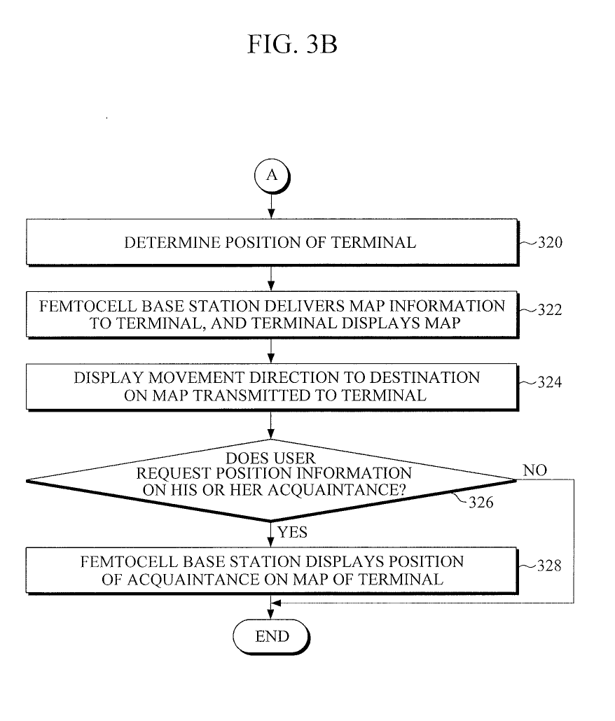

The above-described overall procedure according to an embodiment of the present invention may be illustrated as a flowchart of FIG. 3. FIGS. 3A and 3B are flowcharts illustrating a method of measuring an indoor position of a terminal according to an embodiment of the present invention.

The femtocell base station 102 performs synchronization with sensor transmitters in operation 300. When approach or presence of the terminal 106 is sensed, the femtocell base station 102 performs synchronization with the terminal 106 in operation 302. As described above, a position of the terminal 106 is determined using points in time at which the sensor transmitters have transmitted sensor signals, and points in time at which the terminal 106 receives the sensor signals. Thus, it is necessary for the cellular plane 100 and the sensor plane 120 to have the same timing information so as to accurately calculate a distance and determine the position of the terminal 106, and synchronization is performed through operation 300 and operation 302.

The femtocell base station 102 inquires of the terminal 106 about a destination of a user using a graphical user interface (GUI) in operation 304. Here, input of the destination is not necessarily made by the user, but can be made in various ways, such as, made by an information clerk of the corresponding public place to which a visit appointment has been made instead of the user, or made using appointment information input in advance by the user. When the user wants to respond to the destination inquiry, he or she inputs the destination in the terminal 106 in operation 306. When there is no response to the destination inquiry, the femtocell base station 102 inquires again until a response is received in operation 304, or aborts inquiring (not shown).

The femtocell base station receiving the destination input by the user, etc. instructs the sensor controller 104 to start a sensing routine in operation 308. The sensor controller 104 instructs one of the sensor transmitters 123 to 129 to transmit a sensor signal in operation 310. The sensor receiver 122 installed in the terminal 106 receives the sensor signal from the sensor transmitter. The sensor receiver 122 calculates a distance between the sensor transmitter that has transmitted the sensor signal among the sensor transmitters 123 to 129 and the terminal 106. The method of calculating the distance has been described above.

The terminal 106 receiving the distance information transmits IDs of the sensor transmitters 123 to 129, an ID of the terminal 106 itself, an ID of the sensor transmitter whose sensor signal can be received among the first to seventh sensor transmitters 123 to 129, and distance information on the sensor transmitter whose sensor signal can be received, to the femtocell base station 102 in operation 316. It is determined whether a sensor transmitter index exceeds the total number of sensor transmitters in operation 318. When it is determined that the sensor transmitter index exceeds the total number of sensor transmitters, the process proceeds to operation 310, and transmission continues. In other words, operation 310 to operation 316 are repeated until all the sensor transmitters transmit sensor signals. When sensor signals are received from all the transmitters, the femtocell base station 102 or the sensor controller 104 determines the position of the terminal in operation 320.

The femtocell base station 102 delivers map information to the terminal 106, and the terminal 106 receives the map information, and displays the corresponding map on its display visually, acoustically, or in a combined fashion thereof in operation 322. The terminal 106 displays its position, destination, and movement path on the displayed map in operation 324.

When the user requests position information on his or her acquaintance (or friend) using the terminal 106 to find the position of the acquaintance in operation 326, the femtocell base station 102 finds and displays the position of the acquaintance on the terminal 106 of the user in operation 328. In this case, it is also possible to display a movement path from a current position of the user to the position of the acquaintance.

The method of measuring an indoor position of a terminal described with reference to FIG. 3A and FIG. 3B may be variously used in real life.

In a first use case, it is assumed that a user visits city hall to update his or her driver license. When user A arrives at a public office, for example, city hall, to update his or her driver license, a femtocell base station 102 that is installed in or around city hall to control the area senses approach or presence of a terminal 106 of user A. Here, the femtocell base station 102 may automatically sense approach or presence of the terminal 106, or user A may notify that he or she has come to city hall using the terminal 106, and an information clerk at the information desk of city hall may assist in such a notification operation. The femtocell base station 102 recognizing the presence of the terminal 106, inquires about the purpose of user A's visit to city hall through a terminal GUI screen of user A. The purpose of the visit to city hall may be inquired by the femtocell base station 102 in this way, input by user A or the information clerk, or obtained in a way other than these.

As seen from FIG. 1, an entire system including the femtocell base station 102 has a double network structure, and position information on visitors, such as user A, is found using, for example, a laser-based sensor network. By selecting the purpose or the destination of his or her visit on the terminal 106, user A requests position information related to the selected purpose or destination through the terminal GUI screen.

Using the above-described method, the femtocell base station 102 of the city hall performs all procedures for determining a position of the terminal 106 of user A, and displays the position of user A and a position of and a path to the destination of the visit on the terminal 106 of user A. The path may be an estimated movement path from a current position of user A to the destination of the visit. To maximize visual effects, position information such as the position of user A, the destination of the visit, and the path information may be output in combination with a map geographically showing the inside or the surroundings of city hall.

With reference to the map, user A moves in a direction indicated by the terminal 106, and finally arrives at a place for updating of his or her driver license that is the purpose of the visit. Even when the destination of the visit is plural in number, it is possible to sequentially guide user A to the respective destinations in succession using position information on user A, the destination information, and the map information. Since a procedure and method of guiding a user from one destination to another destination are substantially the same as the method described above, and can be easily implemented by those of ordinary skill in the art, the description will not be reiterated.

In a second use case, it is assumed that a user visits a railroad station to take a train. When user B arrives at a railroad station, e.g., Seoul Station, to take a train departing for Busan at 8 p.m. together with user C who is his or her friend, the femtocell base station 102 of Seoul Station inquires about a train number of the train that user B will take through a terminal GUI screen of user B. A system including the Seoul Station femtocell base station 102 has a double-network structure as shown in FIG. 1, and positions of passengers carrying terminals 106 are sensed using a laser-based sensor network. By selecting the train number of the train that he or she will take, user B requests information on a platform of the selected train through the terminal GUI screen. Here, the train to take may be identified not only by the train number, but also by some or all of a train class, a departure time, and a destination, or by a reservation number, a name, an ID, a membership number, etc. of a subscriber when seats have been reserved in advance.

The Seoul Station femtocell base station 102 performs all procedures for determining a terminal position of user B using the above-described method, and displays a position of user B, and a position of and a path to the destination of the visit, that is, the platform of the train to take, on a terminal 106 of user B. The path may be an estimated movement path from the current position of user B to the platform. To maximize visual effects, position information such as the position of user B, the destination of the visit, and the path information may be output in combination with a map geographically showing the inside or the surroundings of Seoul Station. With reference to the map, user B moves in a direction indicated by the terminal 106, and finally arrives at the destination platform that is the purpose of the visit. Even when the destination of the visit is plural in number, it is possible to sequentially guide user B to the respective destinations in succession using position information on user B, the destination information, and the map information. Since a procedure and method of guiding a user from one destination to another destination are substantially the same as the method described above, and can be easily implemented by those of ordinary skill in the art, the description will not be reiterated.

User B inquires about a position of user C who has promised to take the same train in a Seoul Station femtocell from the Seoul Station femtocell base station 102. At this time, the inquiry may be made through a GUI screen of the terminal 106 of user B, but is not limited to the GUI screen. The position of user C has already been found through a location procedure similar to that of user B, or is found in response to the request of user B. The Seoul Station femtocell base station 102 displays the position of user C on the terminal 106 of user B, and user B may move to the platform from which user B will take the train while frequently checking whether a movement direction of user C is the same as that of user B himself or herself

Even when the destination of the visit is plural in number, it is possible to sequentially guide user A to the respective destinations in succession using position information on user A, the destination information, and the map information. For example, when a user stops at a ticket window to obtain a train ticket on the basis of Internet reservation information and then moves to the corresponding platform, a procedure and method of setting the ticket window as an intermediate destination and the platform as a final destination, and guiding the user to the destinations in sequence are substantially the same as the method described above, and can be easily implemented by those of ordinary skill in the art, and thus the description will not be reiterated.

Although this embodiment has been described with an example of a worldwide interoperability for microwave access (WiMAX) femtocell-based communication network, those of ordinary skill in the art will appreciate that the same technological principle can be applied to communication networks based on various kinds of other communication methods, such as wireless local area network (WLAN), infrared, Bluetooth, radio frequency identification (RFID), and ultra wideband (UWB).

According to an embodiment of the present invention, it is possible to precisely find a position of a terminal in an indoor public place, and guide a user to a spot that the user wants, and the user can readily find the spot that he or she wants.

Even when all components constituting an embodiment of the present invention are combined as one, or are combined and operate in the above description, the present invention is not limited to such an embodiment. In other words, within the aimed scope of the present invention, all the components can be selectively combined as one or more and operate. Also, each of all the components may be implemented as one separate piece of hardware, or some or all of the components may be selectively combined and implemented as a computer program having a program module that performs some or all functions combined from one or a plurality of pieces of hardware. Codes and code segments constituting the computer program can be readily inferred by those of ordinary skill in the art. The computer program is stored in computer-readable media, and read and executed by a computer, thereby implementing an embodiment of the present invention. The storage media may include a magnetic recording medium, an optical recording medium, a carrier wave, and so on.

In addition, it will be understood that the terms “includes,” “including,” “has,” and “having” used above specify the presence of stated components, but do not preclude the presence or addition of other components. Unless otherwise defined, all terms including technical and scientific terms are to be interpreted as is customary in the art to which this invention belongs. It will be further understood that terms in common usage should also be interpreted as is customary in the relevant art and not in an idealized or overly formal sense unless expressly so defined herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for measuring an indoor position of a terminal on the basis of a femtocell, the apparatus comprising:
a femtocell base station including a plurality of sensor transmitters respectively transmitting sensor signals for locating the terminal so that the terminal receives the sensor signals, and a sensor controller controlling operation of the sensor transmitters; and
the terminal configured to receive the sensor signals from the plurality of sensor transmitters, find which sensor transmitters the sensor signals have been transmitted from, and calculate distances between the sensor transmitters having transmitted the sensor signals and the terminal.

2. The apparatus of claim 1, wherein all or some of the plurality of sensor transmitters sequentially transmit the sensor signals while preventing interference between the sensor signals by setting time intervals so that the sensor signals do not temporally overlap.

3. The apparatus of claim 1, wherein the terminal calculates distances between the sensor transmitters having transmitted the sensor signals and the terminal using time differences between transmission and reception of the sensor signals and the velocity of light according to an equation (ti_Rx−ti_Tx)/c, where ti_Rx is a reception point in time, ti_Tx is a transmission point in time, and c is the velocity of light, and provides distance information that is calculation results to the femtocell base station.

4. The apparatus of claim 3, wherein the terminal additionally transmits an identifier (ID) of the terminal itself, and IDs of the sensor transmitters having transmitted the sensor signals to the femtocell base station.

5. The apparatus of claim 4, wherein the position of the terminal is calculated using the distance information and information on directions from the sensor transmitters having transmitted the sensor signals on the basis of the IDs of the sensor transmitters having transmitted the sensor signals.

6. The apparatus of claim 5, wherein a number of sensor transmitters that require the distance information and the direction information to find the position of the terminal and have transmitted the sensor signals, is at least two.

7. The apparatus of claim 1, wherein the femtocell base station additionally includes a map server configured to store image map information that is geographical information on an interior.

8. The apparatus of claim 5, wherein the femtocell base station calculates the position of the terminal using the received distance information and direction information on the basis of image map information on an interior.

9. The apparatus of claim 7, wherein the terminal receives the image map information from the femtocell base station, displays an image map corresponding to the image map information on a display of the terminal, and additionally displays information on the position, information on a destination of a user carrying the terminal, and an estimated path from the position of the terminal to the destination on the image map.

10. The apparatus of claim 9, wherein the terminal updates the position according to movement of the user.

11. The apparatus of claim 10, wherein, when it is determined that the user has deviated from the estimated path, the terminal visually or acoustically notifies the user that he or she has deviated from the estimated path.

12. The apparatus of claim 1, wherein the sensor signals are laser and light detection and ranging (LADAR) signals.

13. An indoor location and path guiding method for a femtocell base station having a plurality of sensor transmitters to measure an indoor position of a terminal having a sensor receiver, the method comprising:
sensing approach or presence of the terminal;
transmitting sensor signals using all or some of the sensor transmitters;
receiving the sensor signals using the sensor receiver, and measuring distances between the terminal and the sensor transmitters having transmitted the sensor signals, and directions from the sensor transmitters having transmitted the sensor signals to the terminal from the received sensor signals to calculate distance information and direction information; and
measuring the position of the terminal using the distance information and the direction information to calculate position information.

14. The method of claim 13, wherein, when sensor the signals are transmitted using all or some of the sensor transmitters, points in time at which the respective sensor transmitters transmit the sensor signals are spaced apart from each other so that the sensor signals transmitted by the different sensor transmitters do not interfere with each other.

15. The method of claim 13, wherein the sensor signals are laser and light detection and ranging (LADAR) signals.

16. An indoor location and movement path guiding method based on a femtocell including a femtocell base station which finds a position of a terminal having a data communication function and guides a user carrying the terminal to a destination when the terminal enters an interior, the method comprising:
sensing approach or presence of the terminal;
receiving an input of a destination that the user wants to go to;
measuring the position of the terminal to calculate position information; and
displaying, at the terminal, an image map stored in the terminal or received from the femtocell base station on a display of the terminal, and displaying the position, the destination, and an estimated path from the position to the destination on the image map.

17. The method of claim 16, wherein the destination is input by the user.

18. The method of claim 16, wherein the position information and the estimated path are updated according to movement of the terminal.

19. The method of claim 18, further comprising, when the user tries to track a person carrying another terminal in the interior, finding a position of the person, calculating a movement path from the user to the person, and then displaying the movement path on the terminal.

20. The method of claim 16, wherein the position information is calculated using information on distances between sensor transmitters positioned at a plurality of spots in the interior and the terminal, and information on directions from the sensor transmitters to the terminal.
